(19) United States
(12) Patent Application Publication
(10) Pub. No.: US 2021/0248672 A1
(43) Pub. Date: Aug. 12, 2021

(54) DATABASE MANAGEMENT SYSTEM USING A MONITORED INFORMATION STREAM FOR ENTRY EXTRACTION AND LINKING

(71) Applicant: Bank of America Corporation, Charlotte, NC (US)

(72) Inventors: Larry M. Borero, Euless, TX (US); Jonathan M. Kaplan, Charlotte, NC (US); Susan Varghese, Atlanta, GA (US); Glenn V. McCormick, II, Wilmington, DE (US); Dipak Dahal, New Castle, DE (US); Mohamed A. Gahnoog, Matthews, NC (US); Khristian W. Hawver-Scott, Buckingham, PA (US); Amy E.G. Johnson, New York, NY (US); Mark A. Fleszar, Bloomfield, MI (US)

(21) Appl. No.: 17/173,650

(22) Filed: Feb. 11, 2021

Related U.S. Application Data
(60) Provisional application No. 62/975,438, filed on Feb. 12, 2020.

(51) Int. Cl. G06Q 40/02; G06Q 30/02; G06Q 20/10

(52) U.S. Cl. CPC G06Q 40/02; G06Q 20/108; G06Q 30/0215

(57) ABSTRACT

A system receives transaction data from data source(s). The system stores a participant entity database. The system determines a first transaction included in the transaction data corresponds to a direct deposit transaction for a payment from a first entity to a recipient. The system determines that the first entity of the first transaction is a participating entity in an enhancement account that provides benefits to members of the participating entity. The system determines that the recipient of the first transaction is both a first member of the first entity and an account holder. The system determines a first account associated with the first account holder and automatically enrolls the first account in the enhancement account.

### CROSS-REFERENCE TO RELATED APPLICATIONS

This application claims benefit of Provisional Application No. 62/975,438 filed Feb. 12, 2020, by Larry M. Borero et al., and entitled “INFORMATION EXTRACTION FOR AUTOMATIC ACCOUNT LINKING AND MANAGEMENT,” which is incorporated herein by reference.

### TECHNICAL FIELD

This disclosure relates generally to information management and, more particularly, a database management system using a monitored information stream for entry extraction and linking.

### BACKGROUND

Big data is a technology that organizations use to process and manage their data. Big data technology allows millions of records to be stored and processed for an organization. Account data is one type of big data that may be associated, for example, accounts associated with providing access to information, user services, or the like. In some cases, a provider of an account may wish to provide special or enhanced benefits to certain accounts.

### SUMMARY

In existing systems, thousands of queries or jobs may be scheduled every day. Due to the volume of jobs that are processed, these systems execute a high volume of operations which consumes a significant amount of the system's resources such as processing power and memory. As an example, the management of user accounts may involve the processing large numbers of jobs and/or large volumes of data. This disclosure recognizes that this high volume of operations associated with account management poses a particular technical challenge when trying to identify and extract information because computer systems are resource-limited and are often unable to provide enough resources to handle the volume of jobs that are required using previous technology. This disclosure recognizes a particular need to provide a way to efficiently process data and to manage system resources for managing user accounts and the various statuses that may be applied to different user accounts, for example, to provide enhanced benefits to accounts.

Certain embodiments of this disclosure solve technical problems of previous technology used for managing databases by providing a data management system that is configured to automatically apply or link enhancement account benefits to appropriate user accounts stored in the database. The disclosed system automatically identifies incoming data that is likely to be associated with participants in the enhancement account program (e.g., data indicating a payment from company whose employees are eligible for an enhancement account) and determines whether the incoming data and an existing account stored in the database satisfy requirements for enrollment in an enhancement account. The disclosed system provides several technical advantages over previous technology, which include: (1) automatic identification of candidate eligible accounts based on monitored data source(s) without requiring large numbers of operations and associated computing costs of individually reviewing all existing account data; (2) efficient linking of eligible accounts to predefined enhancement accounts without processing and memory costs of individually assigning enhancement benefits to individual account entries; and (3) automatic enrollment of eligible accounts without involving repeated communications and consumption of processing and network resources for communicating enrollment requests, evaluating enrollment status, and the like. As such, this disclosure may improve the function of computer systems used for data management. The disclosed system may particularly reduce or eliminate existing bottlenecks to enrolling qualifying accounts in enhancement accounts by performing functions which cannot practically be performed by human operators. This disclosure may particularly be integrated into a practical application of an enhanced account management system that monitors transaction data, identifies a particular qualifying transaction from the monitored data, determines an existing account associated with the qualifying transaction, and automatically enrolls the determined account in an appropriate enhancement account, thereby avoiding the computationally expensive tasks and waste of memory, processing, and network resources expended by previous technology to review each existing account as a possible candidate. Certain embodiments of this disclosure may include some, all, or none of these advantages. These advantages and other features will be more clearly understood from the following detailed description taken in conjunction with the accompanying drawings and claims.

In one embodiment, a system receives transaction data from data source(s). The system stores a participant entity database. The participant entity database includes a record of entities participating in an account enhancement program. The account enhancement program provides an enhancement account to members associated with the participating entity. The enhancement account provides benefits to accounts of the members. The participant entity database includes for each participant entity, a record of members of the participant entity. The system stores a client account database that includes a record of account holders. The system determines a first transaction included in the transaction data corresponds to a direct deposit transaction for a payment from a first entity to a recipient. The system determines, using the participant entity database, that the first entity of the first transaction is one of the participating entities. The system determines, using the participant entity database and the client account database, that the recipient of the first transaction is both a first member of the first entity and a first account holder of the record of account holders. The system determines a first account associated with the first account holder and automatically enrolls the first account in the enhancement account.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an embodiment of a system for automatic account linking and management;

FIG. 2 is an embodiment of a state diagram for an account managed using the system of FIG. 1;

FIG. 3 is an embodiment of a workflow for an automatic account linking and managing process;

FIG. 4 is an embodiment of a workflow for a requirement selection process for automatic account linking and management; and

FIG. 5 is a schematic diagram of an embodiment of a device configured to implement various components of the automatic account linking and management system of FIG. 1.

### DETAILED DESCRIPTION

Disclosed herein are various embodiments of an information system configured to provide automatic account linking and management. The information system overcomes technical challenges of previous technology, including those described above. The information system is generally configured to analyze incoming data from one or more sources to identify accounts that satisfy a set of requirements to be linked with an enhancement account that provides benefits to an account without requiring large volumes of computationally expensive operations for reviewing every item of account information stored as part of a large data set. For example, previous technology may require individual analysis of all data entries for existing accounts. Due to the large number of jobs that must be processed for this analysis, these systems execute a high volume of operations which consume a significant amount of the system's resources such as processing power and memory. In many cases, this analysis may not practically be possible.

The information system of this disclosure solves these problems, at least in part, by monitoring a more computationally manageable volume of data that is received from one or more data sources and following a sequence of processor-implemented refinements to extract relevant information and identify a small subset of existing account information from the large data set that warrants further processing for linking to an enhancement program. As an example, an identified account may be an account that is associated with access to information (e.g., social media information, news, or any other information). In this example, the enhancement account may provide additional benefits (e.g., access to a broader range of information, access to enhanced tools for sharing and/or searching for information, or the like) to the identified account. As another example, an identified account may be an account that is associated with a service (e.g., a data storage service or data streaming service). In this example, the enhancement account may provide additional capabilities (e.g., increased data storage or bandwidth) to the identified account. In other examples, any other suitable type of account may be linked with an enhancement account using the disclosed automatic account linking and management process.

The information system is configured to use a combination of identifiers and requirements to identify accounts that are eligible to receive benefits from the enhancement account. Identifiers are pieces of information that can be used to describe an account. Examples of identifiers include, but are not limited to, customer names, company names, payer names, payee names, account identifiers, transaction types, and any other suitable type of identifier. Requirements are rules that can be used to determine whether an account is eligible to be linked with an enhancement account based on the identifiers associated with the account. After identifying an account that satisfies the requirements, the information system links the identified account with the enhancement account. Linking the account with the enhancement account enables the account to begin receiving benefits from the enhancement account.

The information system is configured to identify and link accounts without requiring information that explicitly identifies which accounts to link with an enhancement account. In addition, the information system is configured to link accounts together without a user requesting their account to be linked with an enhancement account. In other words, the user does not need to enroll or apply to be linked with the enhancement account.

### Enhanced Account Management System

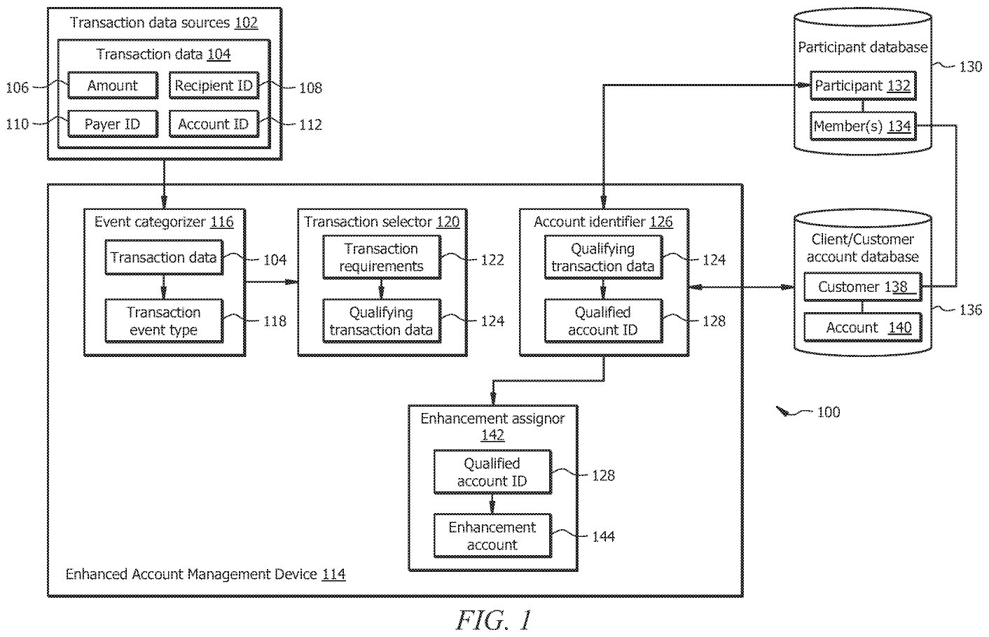

FIG. 1 is a non-limiting example of an information system 100 configured for automatic account linking and managing. In this example, the information system 100 identifies one or more accounts 128 that qualify to be linked with or enrolled in an enhancement account 144, such as a banking and/or investment account with certain benefits (e.g., fee waivers and the like). The information system 100 can generally link or enroll the account(s) 128 in any type of enhancement account 144. The information system 100 includes one or more transaction data sources 102, an enhanced account management device 114, a participant database 130, and a client account database 136.

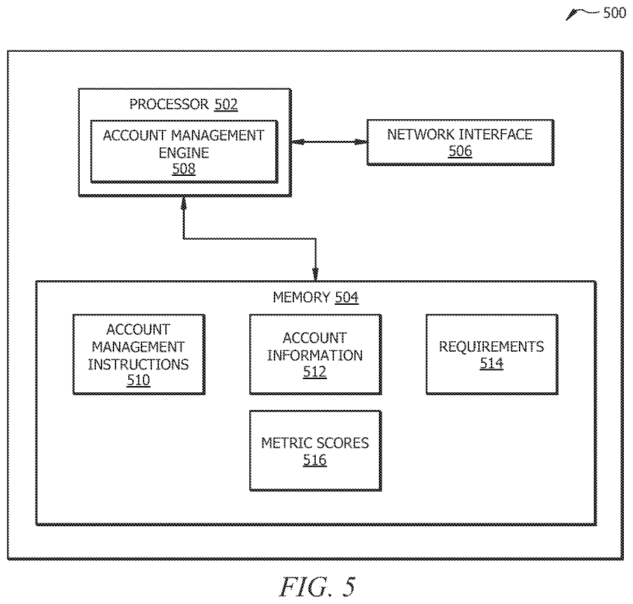

The transaction data sources 102 are generally any sources of data 104 about transactions. The transaction data sources 102 may include banks, mobile applications, online payment services, business, or any other suitable data source. The transaction data 104 generally includes information about transactions between a payer and a recipient. For example, the transaction data 104 may include a transaction amount 106 (e.g., an amount funds transferred in a transaction), a recipient identifier 108 (e.g., a name or other identifier of the recipient of the transferred funds), a payer identifier (e.g., a name or other identifier of the entity providing the funds transferred in the transaction), and an account identifier 112 (e.g., an identifier of the account into which the entity with the payer identifier 110 provided the funds). Each transaction data source 102 may be implemented using the processor, memory, and interface of the device 500 described with respect to FIG. 5 below.

The enhanced account management device 114 is generally configured to receive the transaction data 104 and identify a qualifying account 128 which can be automatically linked with or enrolled in an enhancement account 144. The enhanced account management device 114 may be implemented using the processor, memory, and interface of the device 500 described with respect to FIG. 5 below. The enhanced account management device 114 may periodically receive the transaction data 104.

For example, the enhanced account management device 114 may receive transaction data 104 for a plurality of accounts 140 associated with an entity operating the device 114 (e.g., accounts 140 associated with the client account database 136, described below). As an example, transaction requirements 122 may be used to identify an account 140 that corresponds to a customer 138 that is also a member 134 (e.g., an employee) of a participant 132 in the enhancement account program. A requirement 122 may indicate that the account 140 is also configured to receive direct deposit payments from the participant 132. In this example, the enhanced account management device 114 may first filter the transaction data 104 by identifying data 104 that corresponds with an inbound transaction from a particular participant 132 using the event categorizer 116 (e.g., an event type 118 corresponding to a transfer from the participant 132). The enhanced account management device 114 may then further refine the data 104 (e.g., using the transaction selector 120) by identifying qualifying transaction data 124 that satisfies transaction requirements 122 by corresponding to a direct deposit transaction type 118. The enhanced account management device 114 may even further refine the transaction data 104 by identifying qualifying transaction data 124 that corresponds with a customer identity 138 that corresponds with an employee name 134 for the participant 132 that initiated the transaction. The account 140 for the customer 138 corresponding to this employee/member 134 is identified as a qualified or eligible account 128. In other examples, the information system 100 may use any other suitable type or combination of requirements 122 for identifying an account 128 that is eligible to receive benefits from an enhancement account 144.

The enhanced account management device 114 may include an event categorizer 116 which organizes the received data 104 so that it can be efficiently filtered to search for eligible accounts 128 to enroll in the enhancement account 144. For example, the event categorizer 116 may determine a transaction event type 118 for each transaction included in the transaction data 104. The transaction event type 118 may indicate, for example, whether a transaction is associated with deposit of a check, deposit of cash, a direct deposit of wages from an employer to an employee, or the like.

The enhanced account management device 114 may include a transaction selector 120 that filters the received transaction data 104 to identify a subset 124 of the data 104 that meets at least one of the requirements 122 for being linked with the enhancement account 144. As an example, the transaction selector 120 may filter the received transaction data 104 to identify any data 124 that corresponds with an inbound transaction or a particular transaction type 118. The transaction selector 120 may be configured to use a combination of identifiers 132, 134, 138, 140 and one or more requirements 122 to identify a subset of the transaction data that are qualifying transaction data 124 (e.g., that correspond to account(s) 140 that may be eligible to receive benefits from the enhancement account 144). Identifiers 132, 134, 138, 140 may be obtained from databases 130, 136 (described further below) and are generally any information that can be used to describe an account 140 and/or participant 132 in the enhancement account program.

For example, the transaction selector 120 may select a subset of the transaction data 104 that is qualifying transaction data 124. The qualifying transaction data 124 includes the subset of the transaction data 104 with a transaction type(s) 118 that are eligible for an enhancement account 144 and/or that satisfies requirements 122 that correspond to being eligible for an enhancement account 144. For instance, in some cases, only transaction data 104 associated with direct deposits can qualify for enrollment in an enhancement account 144 (e.g., corresponding to a requirement 122 of a direct deposit transaction type 118). Requirements 122 are generally rules that can be used to determine whether a transaction 104 for an account 128 is eligible to be linked with an enhancement account 144 based on properties of the transaction 104 and the identifiers associated with the account 128.

The transaction selector 120 may further refine the qualifying transaction data 124 to identify data that satisfies other requirements 122 for being linked with the enhancement account 144. For example, the transaction selector 120 may first identify the transaction data 104 that corresponds with a direct deposit payment type 118 and then identify which of these transactions 104 are from a participant 132 (e.g., company) that is eligible for the enhancement account 144. In other examples, the transaction selector 120 may refine the transaction data 104 using any other suitable type or combination of requirements 122.

The enhanced account management device 114 may include an account identifier 126 that uses the qualifying transaction data 124 along with information about participants 132 of the enhancement account program and customers 138 holding accounts 140 that may be eligible for an enhancement account 144 (e.g., to identify qualified accounts 128). In other words, the account identifier 126 identifies the individual customer accounts 140 that are qualified accounts 128 and can be linked with, or enrolled in, the enhancement account 144.

The enhanced account management device 114 may access one or more databases 130, 136 to identify a customer's account 140. Each of the databases 130, 136 may be implemented using the processor, memory, and interface of the device 500 described with respect to FIG. 5 below. The enhanced account management device 114 may use a participant database 130 that includes information about current members 134 (e.g., employees) of participants 132 in the enhancement program. As an example, the enhanced account management device 114 may query the participant database 130 to identify the customers 138 that are members 134 of participants 132 of the enhancement account 144. For instance, the enhanced account management device 114 may extract customer identifiers 138 (e.g., customer names) from the database 130 that correspond to both qualifying transaction data 124 and to a member 134 of a participant 132 in the enhancement account 144.

Once the customers 138 that are eligible for the enhancement account 144 are identified, the account identifier 126 then identifies accounts 140 linked with the identified customers 138. For example, the account identifier 126 may access an account database 136 that includes account information for customers 138. In other examples, database 136 may be integrated with database 130. The account identifier 126 uses the identified customers 138 to look up accounts 140 in the database 136 that correspond with the identified customers 138. Each such identified account 140 is determined to be a qualified account 128.

After a qualified account 128 is determined, the enhanced account management device 114 links the qualified account 128 with the enhancement account 144. For example, an enhancement assignor 142 of the enhanced account management device 114 may link the qualified account 128 with the enhancement account 144. Linking the account 128 with the enhancement account 144 allows the account 128 to begin receiving benefits from the enhancement account 144. For example, the enhancement account 144 may provide discounts, fee waivers, reduced interest rates, and/or any other type of benefits to the qualified account 128. The enhanced account management device 114 may also update information in database 130 and/or database 136 to indicate that the customer's account 140 has been linked with the enhancement account 144.

In some cases, an account 140 may already be linked with one or more enhancement accounts 144. For instance, a person may be a part-time employee of multiple participants 132 that offer enhancement accounts 144. In this case, the enhanced account management device 114 may determine which enhancement account 144 provides the best benefits for the account 140 and then applies the identified enhancement account benefits to the account 140. For example, each enhancement account 144 may be ranked or tiered based on the level of benefits that they provide. The enhanced account management device 114 may select the highest-ranked or highest tiered enhancement account 144 to provided benefits to the account 140.

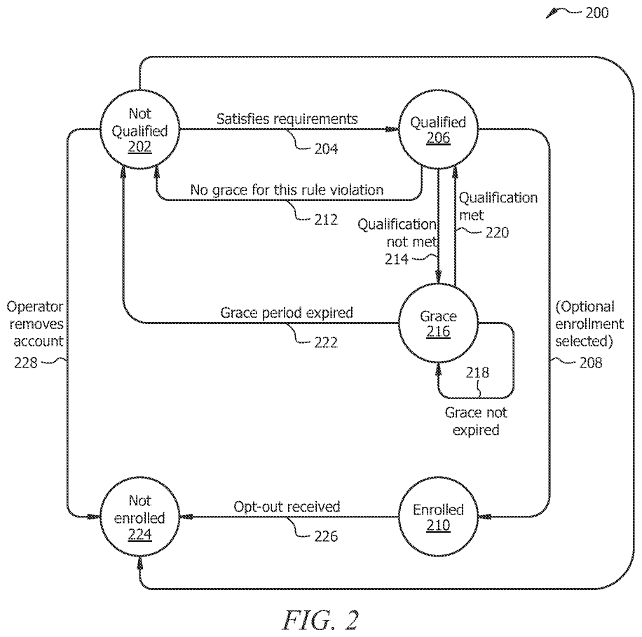

The enhanced account management device 114 may continue to monitor received transaction data 104 to determine whether any of the previously qualified accounts 128 should be removed from the enhancement account 144. For example, the enhanced account management device 114 may receive transaction data 104 that includes recent transaction information for a set of customers 138. The enhanced account management device 114 may identify the transaction data 104 that corresponds with customers 138 with accounts 140 that are already linked with the enhancement account 144. The enhanced account management device 114 then uses the transaction data 104 to determine whether the customer 138 still qualifies for the enhancement account 144 and whether to unlink the customer's account 140 from the enhancement account 144. For example, the enhanced account management device 114 may determine that the customer 138 is no longer using direct deposits which is a requirement 122 for the enhancement account 144. As another example, the enhanced account management device 114 may determine that the customer 138 is no longer receiving payments from the participant 132 that is eligible for the enhancement account 144. In response to determining that the customer 138 no longer satisfies one or more of the requirements 122 for being linked with the enhancement account 144, the enhanced account management device 114 may remove the link between the customer's account 140 and the enhancement account 144 or may place the customer's account into a grace period status (see FIG. 2 and corresponding description below).

As another example, the enhanced account management device 114 may detect that information in the database 130 has changed to remove one of the participants 132, such that the participant 132 no longer provides the enhancement account 144 to its members 134. In response to detecting this change, the enhanced account management device 114 may automatically un-enroll any accounts 140 associated with the removed participant 132 (e.g., to remove accounts 140 from the enhancement account 144 that receive direct deposits from the removed participant 132 or place the accounts 140 in a grace period—see FIG. 2). When the enhanced account management device 114 places the customer's account 140 into a grace period status, the enhanced account management device 114 may send a notification to the customer 138 that identifies how the customer 138 can remedy the missing requirements 122. For example, the notification may inform the customer 138 that they need to re-enroll in direct deposit. The notification may also indicate a grace period in which the customer 138 must resolve any issues associated with missing requirements 122 in order to be re-enrolled in the enhancement account 144. Once the time period elapses, the enhanced account management device 114 may remove the link between the customer's account 140 and the enhancement account 144. Once the link is removed, the customer's account 140 will no longer receive the benefits provided by the enhancement account 144.

### Account Status States

FIG. 2 is an embodiment of a state diagram 200 for an account (e.g., an account 140 of FIG. 1) using automatic account linking and management provided by the enhanced account management device 114 of FIG. 1. The state diagram 200 illustrates the various states 202, 206, 210, 218, 224 for an example account 140 during the process of linking an account 140 with an enhancement account 144 that provides benefits to the account 140.

By default, all new accounts 140 begin in a “not qualified” state 202. This state 202 indicates that the account 140 has not yet been evaluated to determine whether the account 140 is eligible to be linked with the enhancement account 144. The account 140 is then evaluated to determine whether the account 140 satisfies the requirements 122 for linking the account 140 with the enhancement account 144. If the account 140 satisfies 204 the requirements 122, then the account 140 transitions to a “qualified” state 206. If the account 140 does not satisfy the requirements 122, then the account 140 remains in the “not qualified” state 202. After the account 140 transitions to the “qualified” state 206, the account 140 may be automatically enrolled in or linked with the enhancement account 144. In some cases, an enrollment may be selected (step 208), for example, by the customer 138 of the account 140 being linked to the “enrolled” state 210. Once the account 140 is linked with the enhancement account 144, the account 140 is then also associated with an “enrolled” state 210. The “enrolled” state 210 indicates that the account 140 is configured to receive benefits from the enhancement account 144.

Periodically, the account 140 may be reevaluated to determine whether the account 140 still satisfies the requirements 122 for being linked with the enhancement account 144. If the account 140 fails to meet the requirements 122 (at step 214) after being enrolled and the account 140 does not offer a grace period (step 212), the account 140 then transitions to the “not qualified” state 202, and the account 140 changes to the “not enrolled” state 224. If the account 140 fails to meet the requirements 122 (step 214) after being enrolled and the account 140 offers a grace period, the account then transitions to a “grace” state 216. The “grace” state 216 indicates that the account 140 is within a grace period (e.g., a predetermined time period during which the account 140 is allowed to remain in enrolled in the enhancement account 144) to resolve any missing requirements. If the grace period has not yet expired (step 218), the account 140 remains in the “grace” state 216. If the grace period expires (step 222, e.g., if the account does not resolve the missing requirements within a predetermined amount of time), the account 140 then transitions back to the “not qualified” state 202. If the qualifications are met (step 220) during the grace period, the account 140 returns to the “qualified” state 206.

If the account 140 transitions back to the “not qualified” state 202 after being enrolled, the account 140 then is automatically un-enrolled from the enhancement account 144 which removes the association between the account 140 and the enhancement account 144. In this case, the account 140 transitions from the “enrolled” state 210 to a “not enrolled” state 224. The “not enrolled” state 224 indicates that the account 140 is no longer configured to receive benefits from the enhancement account 144. In some cases, the enhanced account management device 114 may receive an opt-out request (step 226), which moves the account 140 from the “enrolled” state 210 to the “not enrolled” state 224.

In some instances, the account 140 may be transitioned to the “not qualified” state 202 and the “not enrolled” state 224 at any time by an operator. For example, the operator may remove (step 228) the link between the account 140 and the enhancement account 144, causing the account 140 to transition from its current state to the “not qualified” state 202 and the “not enrolled” state 210.

### General Process Flow Overview

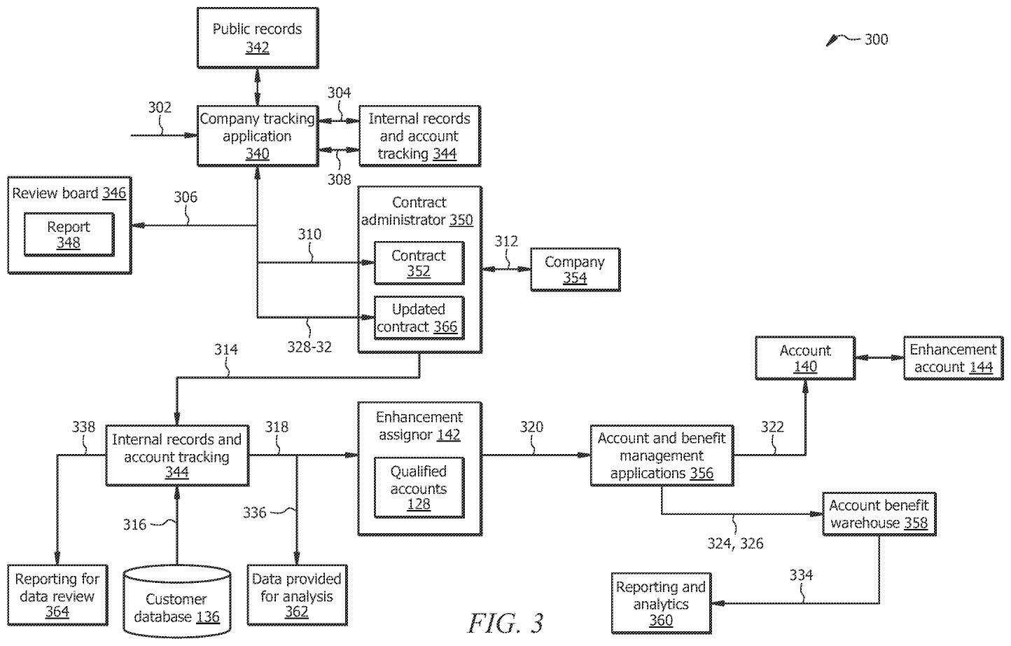

FIG. 3 is an embodiment of a workflow 300 for an automatic account linking and managing process. The workflow 300 may be implemented using the information system 100 of FIG. 1. Steps 302-314 of workflow 300 generally describe an example of a process for determining whether a company 354 is eligible to offer its employees/members 134 an enhancement account 144. At step 302, a company tracking application 340 of the information system 100 receives information that identifies a company 354 as a candidate for offering or automatically providing its employees/members 134 an enhanced account 144. The received information may include a company name, a company identifier, and/or any other suitable information associated with the company 354. At step 304, the information system 100 obtains information about the company 354. This information may be obtained from one or more databases 342, 344. The one or more databases 342, 344 may include, but are not limited to, public records 342 and system-of-records 344 for the information system 100. At step 306, the information system 100 generates and sends a report 348 that identifies vetting metrics to be analyzed by a review board 346. Examples of vetting metrics include, but are not limited to, company age, financial metrics (e.g., account balances), human resource metrics (e.g., number of employees), current service subscriptions, technology area, or any other suitable type of characteristics for a company 354.

At step 308, the information system 100 obtains additional information about the company 354 in response to receiving an approval from the review board 346 for the company 354. At step 310, the information system 100 generates a contract 352 for onboarding the company 354. The contract 352 may be generated using a contract administrator application 350. The contract 352 may determine identifiers for identifying accounts 140, requirements 122 for an account 140 to be eligible to link with the enhancement account 144, benefits for accounts 140 linked with the enhancement account 144, and/or any other suitable type of information. At step 312, the information system 100 sends the contract 352 to the company 354 for approval. At step 314, the information system 100 records information about the contract 352 in response to receiving an approval from the company 354 for the contract 352 (e.g., in an internal database 344). Once the information system 100 receives the approved contract 352, the information system 100 may then begin providing services to the company 354 by linking member accounts 140 with an enhancement account 144 (as described below and above with respect to FIGS. 1 and 2).

Steps 316 and 318 generally describe a process for identifying new accounts 140 associated with the company 354 (e.g., which is now a participant 132 in the enhancement account program) that is eligible for benefits via the enhancement account 144 established by the contract 352. At step 316, the information system 100 receives data associated with a plurality of accounts 140. For example, the received data may include transaction information 104 for a plurality of customer accounts 140. At step 318, the information system 100 uses the identifiers 132, 134, 138, 140 and requirements 122 associated with the contract 352 for the company 354 to identify accounts 140 that are associated with the company 354 and are eligible to receive benefits from an enhancement account 144 for the company 354 (see also FIGS. 1 and 2). In some embodiments, the transaction data 104 may be provided at step 336 for data analysis 362 and/or at step 338 for reporting and/or other data review 364.

Steps 320 and 322 generally describe a process for providing benefits to an account 144 (e.g., a qualified account 128). At step 320, the information system 100 receives (e.g., at one or more applications 356 configured for account and benefit management) information about the benefits that an account 140 is configured to receive based on the enhancement account 144 indicated by the contract 352 with the company 354. At step 322, the information system 100 links the account 140 to the enhancement account 144 and applies the corresponding benefits to the account 140.

Steps 324 and 326 generally describe a process for collecting information about accounts 140 that are currently configured to receive benefits from the enhancement account 144. At step 324, the information system 100 collects historical information to identify any benefits that an account 140 has received. At step 326, the information system 100 stores the collected information (e.g., in an account benefit warehouse 358 or any other database(s)) about the benefits that the account 140 has received. The information system 100 may evaluate and track the collected information for quality control. For example, at step 334, the information may be provided for reporting and/or analytics 360.

Steps 328-332 generally describe an example of a process for updating the contract 352 or agreement with the company 354. At step 328, the information system 100 receives information about updates or changes to the contract 352 with the company 354. For example, the information system 100 may request a contract renewal, a contract termination, a modification to the requirements for the contract 352, a modification to the identifiers used to identify eligible accounts 140 associated with the company 354, or any other suitable type of update or modification to the contract 352. At step 330, the information system 100 updates the company contract 352 to generate updated contract 366 based on the received information. At step 330, the information system 100 executes the updated company contract 366.

### Requirement Selection Process

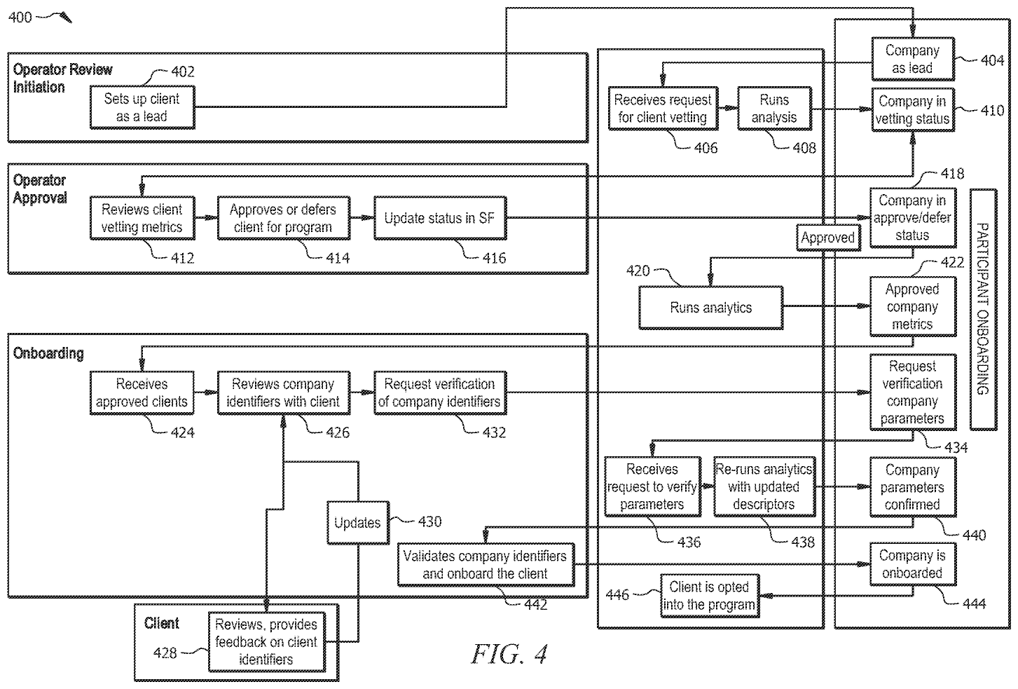

FIG. 4 is an embodiment of a workflow 400 for a requirement 122 selection process for automatic account linking and management using the information system 100 of FIG. 1. At step 402, an operator may identify a company (e.g., a company 354 of FIG. 3) as a lead or candidate for participating in an enhancement account program, or service, that links member accounts 140 with an enhancement account 144 (e.g., a company as a candidate to include as a participant 132). In this example, the company may already have a previous relationship with the information system 100 (e.g., or an operator of the information system 100). For example, the information system 100 may already be configured to provide one or more services to the identified company, as participant 132. In other examples, the company may not have a previous relationship with the information system 100 and may be a new client for services. The operator generates a request for client vetting that identifies the company as a lead for a service. The operator then sends the request for client vetting to the information system 100 for processing. At step 404, the status of the company in the onboarding process is set to “lead” (e.g., or “candidate”), which indicates that the company is ready for review.

At step 406, the information system 100 receives the request for client vetting that identifies the company. At step 408, the information system 100 runs analytics on the company to determine metric values for different characteristics of the company. For example, the information system 100 may access information from one or more databases (e.g., the participant database 130 of FIG. 1 and/or one or more databases 342, 344 of FIG. 3) to evaluate and score different characteristics of the company. Examples of company characteristics include, but are not limited to, company age, financial metrics (e.g., account balances), human resource metrics (e.g., number of employees), current service subscriptions, technology area, or any other suitable type of characteristics for a company. The information system 100 may evaluate and score any number of company characteristics. For example, the information system 100 may be configured with a predetermined list of company characteristics to evaluate and rules for scoring each characteristic. For instance, a company with a larger number of employees may receive a higher metric value score than a company with a smaller number of employees. The information system 100 may use any suitable type of rules or threshold values for determining metric value scores (e.g., scores 516 of FIG. 5). After determining the metric values scores for the company, the information system 100 sends the metric score values to the operator for review (e.g., as part of reporting 348 of FIG. 3). At step 410, the status of the company in the onboarding process is set to “in vetting” which indicates that the company is pending approval.

At step 412, the operator receives the metric values scores for the company. At step 414, the operator determines whether to approve or deny the company for the service based on the company's metric values scores. For example, the operator may determine that the company meets the requirements to be eligible for the service based on the company's metric values scores (e.g., a subset of the requirements 122 of FIG. 1). At step 416, the operator sends a notification that indicates whether the company is approved, denied, or deferred to the information system 100. At step 418, the status of the company in the onboarding process corresponds with the determination made in step 414.

At step 420, the information system 100 determines whether the company has been approved for further processing. If the company has been approved for further processing, then the information system 100 determines one or more identifiers that can be used to identify accounts 140 associated with the company that is eligible for the service. For instance, the identifiers may include names of the company or participant 132 and/or names of members 134 or employees of the company/participant 132. At step 422, the status of the company in the onboarding process is set to indicate that the determined company identifiers are pending approval.

At step 424, the operator receives the determined company identifiers for review. Here, the operator may approve, deny, or modify which identifiers are used to identify accounts 140 associated with the company that is eligible for the service. In some cases, at step 426, the operator may send the determined company identifiers to a representative from the company for further review and approval (e.g., to determine that company name, employee name, and/or the like is correct and/or presented in an appropriate format). At step 428, the company representative may approve, deny, or modify which identifiers are used to identify accounts 140 associated with the company that is eligible for the service. At step 430, the company representative sends the updated approved company identifiers back to the operator. At step 432, the operator sends the approved company identifiers back to the information system 100. At step 434, the status of the company in the onboarding process is set to indicate that the company identifiers are pending verification.

At step 436, the information system 100 receives the request to verify the approved company identifiers. At step 438, the information system 100 verifies that the approved company identifiers are valid for identifying accounts 140 associated with the company. At step 440, the status of the company in the onboarding process is set to indicate that the company identifiers have been verified.

At step 442, the operator receives a notification that the company identifiers have been verified and that the company is ready to receive the service. At step 444, the status of the company in the onboarding process is set to indicate that the company is ready to receive the service.

At step 446, the information system 100 begins identifying accounts 140 associated with the company that is eligible for the service based on the approved company identifiers (e.g., according to the examples of FIGS. 1-3, described above).

### Device Hardware Configuration

FIG. 5 is an embodiment of a device 500 configured to implement the automatic account linking and managing process described in this disclosure. The device 500 may be used to implement the transaction data sources 102, enhanced account management device 114, the participant database 130, and/or the customer database 136 of FIG. 1. The device 500 comprises a processor 502, a memory 504, and a network interface 506. The device 500 may be configured as shown or in any other suitable configuration.

The processor 502 comprises one or more processors operably coupled to the memory 504. The processor 502 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 502 may be a programmable logic device, a microcontroller, a microprocessor, or any suitable combination of the preceding. The processor 502 is communicatively coupled to and in signal communication with the memory 504. The one or more processors are configured to process data and may be implemented in hardware or software. For example, the processor 502 may be 8-bit, 16-bit, 32-bit, 64-bit or of any other suitable architecture. The processor 502 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute instructions to implement an account management engine 508. In this way, processor 502 may be a special purpose computer designed to implement the functions disclosed herein. In an embodiment, the account management engine 508 is implemented using logic units, FPGAs, ASICs, DSPs, or any other suitable hardware. The account management engine 508 is configured operate as described in FIGS. 1-4. The account management engine 508 may be configured to perform the operations described in FIGS. 1-4. For example, the account management engine 508 may be configured to operate as the enhanced account management device 114 of FIG. 1 and/or to analyze data using the process described in FIGS. 1-4 to identify accounts 140 that satisfy a set of requirements to be linked with an enhancement account 144 that provides benefits to the accounts 140. After identifying an account 140 that satisfies the requirements 144, the account management engine 508 is configured to link the identified account 140 with the enhancement account 144.

The memory 504 comprises one or more disks, tape drives, or solid-state drives, and may be used as an over-flow data storage device, to store programs when such programs are selected for execution, and to store instructions and data that are read during program execution. The memory 504 may be volatile or non-volatile and may comprise read-only memory (ROM), random-access memory (RAM), ternary content-addressable memory (TCAM), dynamic random-access memory (DRAM), and static random-access memory (SRAM).

The memory 504 is operable to store account management instructions 510, account information 512, requirements 514, metric scores 516, and/or any other data or instructions. The account management instructions 510 may comprise any suitable set of instructions, logic, rules, or code operable to execute the account management engine 508. The account management instructions 510 may include any suitable set of instructions, logic, rules, or code operable to execute the various applications 340, 350, 356 of FIG. 3. The account information 512 comprises information about employees of a company that is eligible for the enhancement account 144, account information for customers or members 134, and/or any other suitable type of information. The requirements 514 comprise one or more requirements 122 for linking an account 140 with an enhancement account 144. The metric scores 516 are any scores or measures determined, based on different characteristics of companies or other entities, for identifying candidates to include as new participants 132, as described, for example, with respect to FIG. 4 above.

The network interface 506 is configured to enable wired and/or wireless communications. The network interface 506 is configured to communicate data between the device 500 and other devices, systems, or domain. For example, the network interface 506 may comprise a WIFI interface, a LAN interface, a WAN interface, a modem, a switch, or a router. The processor 502 is configured to send and receive data using the network interface 506. The network interface 506 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system comprising:
one or more transaction data sources configured to store transaction data, wherein the transaction data comprises properties associated with a plurality of transactions between payers and recipients; and
an account management device comprising:
a network interface configured to receive the transaction data from the one or more data sources;
a memory configured to store:
a participant entity database comprising:
a record of participant entities participating in an account enhancement program, wherein the account enhancement program provides an enhancement account to members associated with the participant entity, wherein the enhancement account provides benefits to accounts of the members; and
for each participant entity, a record of members of the participant entity; and
a client account database comprising a record of account holders; and
a processor communicatively coupled to the network interface and the memory and configured to:
determine a first transaction included in the transaction data corresponds to a direct deposit transaction for a payment from a first entity to a recipient;
determine, using the participant entity database, that the first entity of the first transaction is one of the participant entities of the record of participant entities participating in the account enhancement program;
determine, using the participant entity database and the client account database, that the recipient of the first transaction is both a first member of the first entity and a first account holder of the record of account holders;
determine a first account associated with the first account holder; and
automatically enroll the first account in the enhancement account.

2. The system of claim 1, wherein the processor is further configured to, following enrolling the first account in the enhancement account:
detect that the first entity is no longer included in the entities participating in the account enhancement program; and
in response to detecting that the first entity is no longer included in the entities participating in the account enhancement program, automatically un-enroll the first account from the enhancement account.

3. The system of claim 1, wherein the processor is further configured to:
determine that the first account no longer satisfies criteria for being enrolled in the enhancement account; and
in response to determining that the first account no longer satisfies the criteria, allow the first account to remain enrolled in the enhancement account for a grace period;
after completion of the grace period, determine that the first account still fails to satisfy the criteria; and
in response to determining that the first account still fails to satisfy the criteria after completion of the grace period, automatically un-enroll the first account from the enhancement account.

4. The system of claim 3, wherein the criteria comprise a requirement for at least one direct deposit transaction between the first entity and the first account holder.

5. The system of claim 1, wherein the processor is further configured to, prior to enrolling the first account in the enhancement account:
provide an enrollment option to the first account holder; and
in response to receiving an approval to enroll in the enhancement program, enroll the first account in the enhancement account.

6. The system of claim 1, wherein the processor is further configured to, after enrolling the first account in the enhancement account:
receive an opt-out request from the first account holder; and
in response to receipt of the opt-out request, un-enroll the first account from the enhancement account.

7. The system of claim 1, wherein the processor is further configured to:
determine a second transaction included in the transaction data corresponds to a direct deposit transaction for a payment from a second entity to a second account holder;
generate and provide a report comprising information about the second transaction and the second entity;
after providing the report, receive an indication that the second entity qualifies to participate in the account enhancement program; and
after receiving the indication that the second entity qualifies to participate in the account enhancement program, add the second entity as a second participating entity in the record of participant entities participating in the account enhancement program.

8. A method, the method comprising, by a processor of a computing device:
monitoring transaction data stored in one or more transaction data sources, wherein the transaction data comprises properties associated with a plurality of transactions between payers and recipients;
determining a first transaction included in the transaction data corresponds to a direct deposit transaction for a payment from a first entity to a recipient;
accessing information from a participant entity database comprising:
a record of participant entities participating in an account enhancement program, wherein the account enhancement program provides an enhancement account to members associated with the participating entity, wherein the enhancement account provides benefits to accounts of the members; and
for each participant entity, a record of members of the participant entity;
determining, using the information accessed from the participant entity database, that the first entity of the first transaction is one of the participant entities of the record of participant entities participating in the account enhancement program;
accessing information in a client account database comprising a record of account holders;
determining, using the information access from the participant entity database and the client account database, that the recipient of the first transaction is both a first member of the first entity and a first account holder of the record of account holders;
determining a first account associated with the first account holder; and
automatically enrolling the first account in the enhancement account.

9. The method of claim 8, further comprising, following enrolling the first account in the enhancement account:
detecting that the first entity is no longer included in the entities participating in the account enhancement program; and
in response to detecting that the first entity is no longer included in the entities participating in the account enhancement program, automatically un-enrolling the first account from the enhancement account.

10. The method of claim 8, further comprising:
determining that the first account no longer satisfies criteria for being enrolled in the enhancement account; and
in response to determining that the first account no longer satisfies the criteria, allowing the first account to remain enrolled in the enhancement account for a grace period;
after completion of the grace period, determining that the first account still fails to satisfy the criteria; and
in response to determining that the first account still fails to satisfy the criteria after completion of the grace period, automatically un-enrolling the first account from the enhancement account.

11. The method of claim 10, wherein the criteria comprise a requirement for at least one direct deposit transaction between the first entity and the first account holder.

12. The method of claim 8, further comprising, prior to enrolling the first account in the enhancement account:
providing an enrollment option to the first account holder; and
in response to receiving an approval to enroll in the enhancement program, enrolling the first account in the enhancement account.

13. The method of claim 8, further comprising, after enrolling the first account in the enhancement account:
receiving an opt-out request from the first account holder; and
in response to receipt of the opt-out request, un-enrolling the first account from the enhancement account.

14. The method of claim 8, further comprising:
determining a second transaction included in the transaction data corresponds to a direct deposit transaction for a payment from a second entity to a second account holder;
generating and providing a report comprising information about the second transaction and the second entity;
after providing the report, receiving an indication that the second entity qualifies to participate in the account enhancement program; and
after receiving the indication that the second entity qualifies to participate in the account enhancement program, adding the second entity as a second participating entity in the record of participant entities participating in the account enhancement program.

15. A device comprising:
a network interface configured to communicate with one or more transaction data sources, the one or more transaction data sources configured to store transaction data, wherein the transaction data comprises properties associated with a plurality of transactions between payers and recipients; and
a memory configured to store:
a participant entity database comprising:
a record of participant entities participating in an account enhancement program, wherein the account enhancement program provides an enhancement account to members associated with the participating entity, wherein the enhancement account provides benefits to accounts of the members; and
for each participant entity, a record of members of the participant entity; and
a client account database comprising a record of account holders; and
a processor communicatively coupled to the network interface and the memory and configured to:
determine a first transaction included in the transaction data corresponds to a direct deposit transaction for a payment from a first entity to a recipient;
determine, using the participant entity database, that the first entity of the first transaction is one of the participant entities of the record of participant entities participating in the account enhancement program;
determine, using the participant entity database and the client account database, that the recipient of the first transaction is both a first member of the first entity and a first account holder of the record of account holders;
determine a first account associated with the first account holder; and
automatically enroll the first account in the enhancement account.

16. The device of claim 15, wherein the processor is further configured to, following enrolling the first account in the enhancement account:
detect that the first entity is no longer included in the entities participating in the account enhancement program; and
in response to detecting that the first entity is no longer included in the entities participating in the account enhancement program, automatically un-enroll the first account from the enhancement account.

17. The device of claim 15, wherein the processor is further configured to:
determine that the first account no longer satisfies criteria for being enrolled in the enhancement account, wherein the criteria comprise a requirement for at least one direct deposit transaction between the first entity and the first account holder; and
in response to determining that the first account no longer satisfies the criteria, allow the first account to remain enrolled in the enhancement account for a grace period;
after completion of the grace period, determine that the first account still fails to satisfy the criteria; and
in response to determining that the first account still fails to satisfy the criteria after completion of the grace period, automatically un-enroll the first account from the enhancement account.

18. The device of claim 15, wherein the processor is further configured to, prior to enrolling the first account in the enhancement account:
provide an enrollment option to the first account holder; and
in response to receiving an approval to enroll in the enhancement program, enroll the first account in the enhancement account.

19. The device of claim 15, wherein the processor is further configured to, after enrolling the first account in the enhancement account:
receive an opt-out request from the first account holder; and
in response to receipt of the opt-out request, un-enroll the first account from the enhancement account.

20. The device of claim 15, wherein the processor is further configured to:
determine a second transaction included in the transaction data corresponds to a direct deposit transaction for a payment from a second entity to a second account holder;
generate and provide a report comprising information about the second transaction and the second entity;
after providing the report, receive an indication that the second entity qualifies to participate in the account enhancement program; and
after receiving the indication that the second entity qualifies to participate in the account enhancement program, add the second entity as a second participating entity in the record of participant entities participating in the account enhancement program.
